(19) United States
(12) Patent Application Publication
(10) Pub. No.: US 2010/0043046 A1
(43) Pub. Date: Feb. 18, 2010

(54) Internet video receiver

(76) Inventors: Shondip Sen, Staines (GB); Shamir Sen-Gupta, San Jose, CA (US); Julian Frank Fields, JR., San Jose, CA (US)

Correspondence Address: GEORGE M STERES, 20200 PIERCE RD, SARATOGA, CA, 95070, US

(21) Appl. No.: 12/459,664

(22) Filed: Jul. 6, 2009

Related U.S. Application Data
(60) Provisional application No. 61/134,306, filed on Jul. 7, 2008.

(51) Int. Cl. H04N 7/173

(52) U.S. Cl. 725/133

(57) ABSTRACT

An Internet Video Receiver (IVR) is an appliance for delivering content from the Internet for viewing on a television screen or other device. The major contribution that we have made is to shift the position where advertising is merged with content in the delivery of television services. Previously, content was delivered by a single service provider through a closed medium to many clients. The content and advertising was preselected by the service provider at the server side and delivered to the television on the client side with limited customization for individual viewers. With an IVR, the user can choose content from many independent suppliers from the Internet which is merged with independently supplied advertising in the IVR at the client side. Merging content with advertising in the IVR at the client side provides a new method for delivering a customized television service that can be tailored to individual viewers. Statistical information about content that has been viewed using the IVR is collected at the client side and is sent to destinations on the server side independently of the content and/or advertising suppliers. All information crossing the client/server boundary between the IVR on the client side and independent services on the server side in either direction are transactions for which a fee can be charged.

### REFERENCES CITED

U.S. Patent Documents

| | | | |
|---|---|---|---|
| 4,887,204 | December 1989 | Johnson et al. | 364/200; 364/283.1; 364/228.3; |
| | | | 36424341 |
| 4,907,086 | March 1990 | Truong | 358/183; 340/734; 340/791 |
| 5,313,646 | May 1994 | Hendricks et al. | 395/600; 395/435; 395/160; 364DIG1; |
| | | | 36422281; 364/282.1; 364/283.1; |
| | | | 364/286 |
| 5,491,517 | February 1996 | Kreitman et al. | 348/581; 348/586; 348/599; 348/722 |
| 5,603,019 | February 1997 | Kish | 395/621; 395/413; 395/444; 395/481; |
| | | | 39520012; 364/256.3; 364/962; |
| | | | 364DIG1; 364DIG2 |
| 6,078,328 | June 2000 | Schumann et al. | 345/418 |
| 6,195,692 | February 2001 | Hsu | 709/219; 345/327; 348/906; 348/565 |
| 6,573,945 | June 2003 | Wu et al. | 348/584; 348/581; 348/587; 348/588; |
| | | | 348/589; 345/641 |
| 2007/0130601 | June 2007 | Li et al. | 725112000; 725113000 |
| 7,017,175 | Mar. 21, 2006 | Alao, et al. | 725/105; 348/E7.054; 348/E7.07; |
| | | | 709/203; 725/109 |
| 20020087402 | Jul. 4, 2002 | Zustak, Fred J.; et al. | 705/14; 705/26 |
| 20020124249 | Sep. 5, 2002 | Shintani, Peter Rae; et al. | 725/32; 348/E7.075; 386/E5.001; |
| | | | 725/105; 725/131 |
| 20040163101 | Aug. 19, 2004 | Swix, Scott R.; et al. | 725/9; 348/E7.075; 705/10; 725/35; |
| | | | 725/36 |
| 20040226034 | Nov. 11, 2004 | Kaczowka, Peter A.; et al. | 725/9; 386/E5.001; 725/10; 725/34; |
| | | | 725/35; 725/46 |
| 20050132420 | Jun. 16, 2005 | Howard, Daniel H.; et al. | 725/135; 348/E5.099; 348/E5.103; |
| | | | 348/E7.071; 704/246 |
| 20050251820 | Nov. 10, 2005 | Stefanik, John R.; et al. | 725/34; 348/E5.099; 375/E7.023; |
| | | | 725/14; 725/35; 725/46 |
| 20080046942 | Feb. 21, 2008 | Merlin; Yakkov | 725/110 |
| 20080092176 | Apr. 17, 2008 | Raftelis; Michael Thomas; et al. | 725/61; 348/E7.071; 725/100; |
| | | | 725/105; 725/131; 725/60 |
| 20080127250 | May 29, 2008 | DaCosta; Behram Mario | 725/34 |
| 20080155592 | Jun. 26, 2008 | Walter; Edward A.; et al. | 725/34 |
| 20090158344 | Jun. 18, 2009 | Anglin, JR.; Richard L. | 725/46 |
| 20060010470 | Jan. 12, 2006 | Kurosaki; Daisuke; et al. | 725/46; 348/E5.105; 725/29 |

### PRIORITY

This application claims the priority date of Jul. 7, 2008 based on the Provisional Patent Application No. 61/134,306 filed Jul. 7, 2008.

### BRIEF DESCRIPTION OF THE DRAWINGS

FIG. 1: Existing Client/Server Model for terrestrial, satellite, cable and IPTV.

FIG. 2: Media Center/Streamer devices are able to access content from the network to display on a television.

FIG. 3: IVR merges content and advertising from independent sources at the client side. Statistics are collected and sent to servers independently of content and advertising.

FIG. 4: Content and Messages merged by IVR and displayed on the screen as overlays.

FIG. 5: Virtual file system (VFS) organizes content into a hierarchical playlist. Content accessible through the VFS can be stored in the local memory of the IVR or can be accessed remotely from the Internet or the local area network.

FIG. 6: IVR connects to a television or other device through a digital card/slot/port e.g. an SD memory card slot or USB port.

FIG. 7: IVR is an external set-top-box connected to the television or other device through audiovisual connectors.

FIG. 8: IVR is integrated into a television or other device.

FIG. 9: IVR is integrated into a television or other device with an external source.

FIG. 10: IVR is an external set-top-box connected to the television or other device through audiovisual connectors. The IVR has an external source.

### BACKGROUND

1. Field of the Invention

This invention relates to delivery of media content that can be displayed on a television set, including advertising content.

2. Related Prior Art

Historically, television has been a one-way communication medium with a single broadcaster transmitting content and advertising to many receivers. Different technologies have facilitated the delivery of television through terrestrial broadcasting, satellite, cable and Internet Protocol Television (IPTV). Some of these technologies have enabled two-way communication between the television and the broadcaster, for example Video-on-Demand (VOD). However, in each case a similar model of delivery has been employed where there is one supplier who provides the content and advertising to all of the televisions due to ownership of the communication medium.

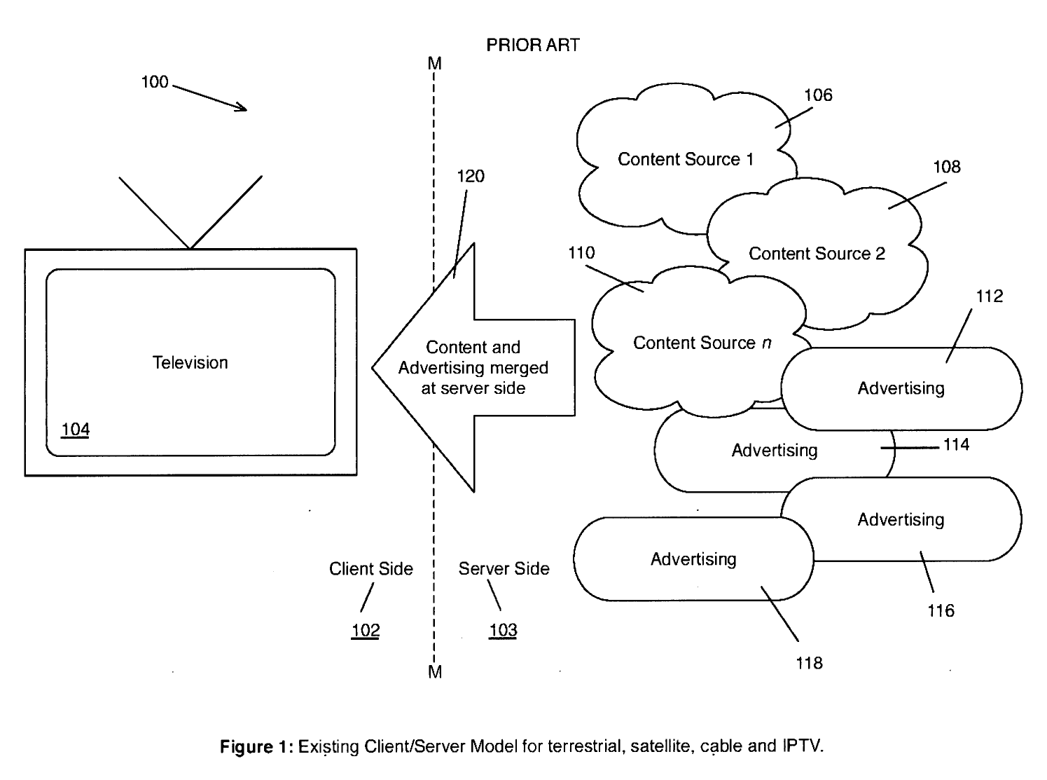

FIG. 1 Existing Client/Server Television Delivery System

FIG. 1 illustrates the existing method for delivering television services within the context of a client/server model 100 where the broadcaster of the TV services is on the server side 103[SS1] of a delivery medium (indicated by line M-M) and the television 104 represents a single client on the client side 102 of medium M-M. In model 100, there is typically a single server 120 for many clients. The relationship between servers and clients is one-to-many. The client 102 can choose from a number of predetermined [SS2]content sources 106-110[SS3] from different television stations or services but is limited to those which are available from the server 120 due to the physical constraints of the delivery medium, represented by the dashed line M-M such as a broadcasting tower or the cable that runs beneath the road.

In model 100 one or more content sources 106-110 are typically merged with selected ones of advertising media 112-118. The merging, if any, is done o the server side 103, prior to delivering the merged content 130 to the client 104. on the client side 102.

The existing client/server model is illustrated in FIG. 1 of U.S. Pat. No. 6,195,692 to Hsu et al. incorporated herein by reference, where content from the Internet is aggregated by a service at the server side before it is broadcast via a cable, terrestrial or satellite link.

Using existing cable, terrestrial or satellite links for delivering content 106-118 to a television 104 limit the user to a single supplier/server 120 because of the closed delivery medium M-M connecting the single supplier/server 120 to the user's equipment 104 Another example of the existing client server model is illustrated in U.S. Pat. App. 2007/0130601 A1 by Li et al. incorporated herein by reference where the client can decide when to insert commercial breaks but a ‘Central Media Streaming Server’ delivers all content.

A traditional set-to-box used in a conventional client-server system model acts as a relatively simple terminal to a service that is delivered through a dedicated link to a server. Many video services, set-top-box and Internet television appliances are able to insert overlay messages onto the content being played. The problem with the existing approach is that the overlays are determined by a single content creator/provider/broadcaster at the server side.

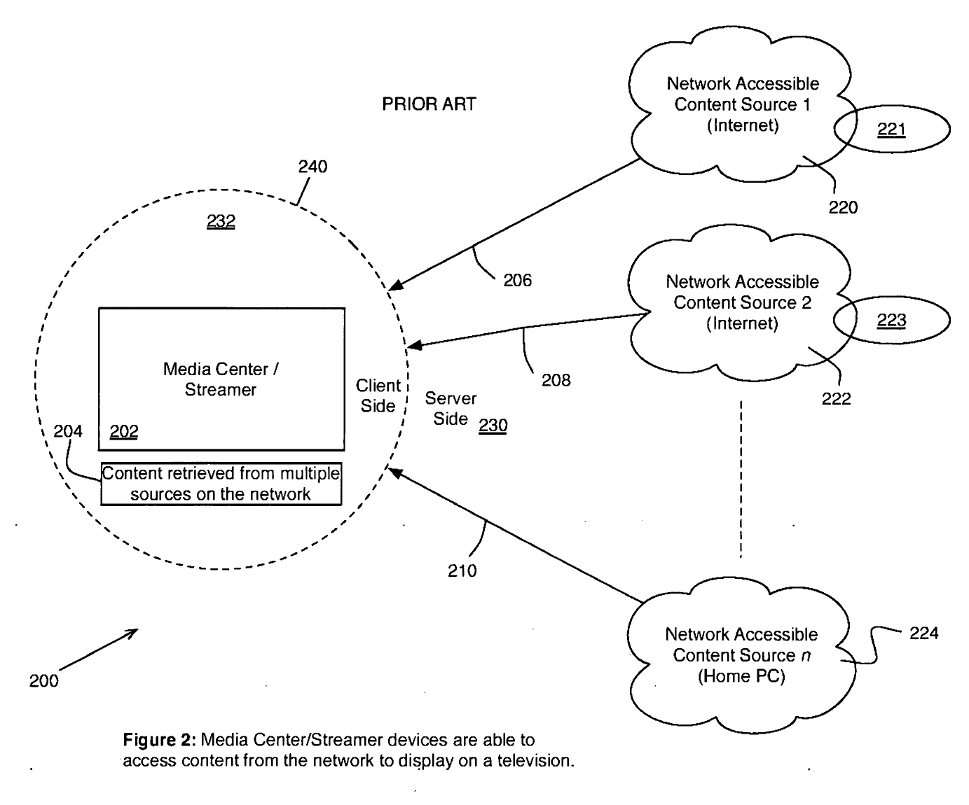

FIG. 2: Existing Media/Streamer Delivery System[SS4]

Referring now to FIG. 2 there is shown another existing client-server media/streamer model 200 of a TV delivery system. System 200 uses one of a number of existing media centers/streamers appliance 202. These media centers/streamers appliance are able to retrieve content from one or more sources and deliver this to a television set. In FIG. 2 the streamer 202 retrieves streaming content 204 from signals 206, 208, 210 provided by respective Network Accessible Content sources 220, 222 & 224 [SS5] on the server side 230 and presents it to be played on a local TV set (not shown). Dashed line 240 represents the communication boundary (delivery medium) between the remote server side 230 one side and the local Media Center/Streamer 202 on the Client side 232.

The signals 206-210 from Network Accessible Content 220-224 are retrieved via a wired Ethernet or, wireless LAN and the like (not shown).

Here, as is the case with the Client Server model of FIG. 1, merging of advertising if any, with content is done on the server side before delivery to the Streamer 202 on the client side.

Merging of sources such as content sources 220, 222 and advertising sources 221, 223 is done on the server side 230. Such server-side merging may be done either within one or more of the network (e.g., the Internet) accessible sources 220, 222 or by a media delivery operating entity (not shown) tasked with communicating the merged content 206-210 to the Media Center/Streamer 202 on the client side 232.

One disadvantage of existing methods like these for delivering content to a television is that access is limited to only certain approved suppliers/servers because of the closed nature of the media center 202 and therefore the delivery medium.

### SUMMARY OF THE INVENTION

Internet Video Receiver (IVR) is an appliance for accessing and viewing content on a television [SS6]from multiple locations including a home network and the Internet. The IVR extends the capabilities offered by the existing Client Server models by adding a second source of content, primarily advertising, that is merged at the client side, with the other content retrieved by the IVR. The IVR enables advertising to be supplied independently of the other content retrieved.

The IVR also has the ability to identify the content being viewed by the user on the client side, to gather statistics about such viewing and to provide access to such statistics to authorized third parties who are independent of the suppliers of the content and the suppliers of the advertising merged with the viewed content.

With an IVR a user is not limited in choosing content to be delivered because of a single supplier/server delivering over a closed delivery system.

A major feature of the present invention is to move control over the sources of content from the server side to the client side allowing the user to choose content from multiple independent sources accessible through the network. A further capability of the present invention is to merge content with advertising, messages and notifications from other independent server side sources at the client side, enabling customized and unique services for each viewer. Statistics are gathered at the client side for viewed content and sent to one or more independent destinations on the server side[GMS7]. The IVR can collect statistical information which is sent to the server side independently from the sources of content and advertising, which allows the identity of the content being played to be determined for the purpose of delivering customized services to the user at the client side.

An IVR is able to merge content with messages and advertising at the client side, providing a service that is customized or targeted to individuals (users) viewing the television screen.

These capabilities allow customization of the service to be shifted to the client side within the IVR creating a unique service and experience for each user.

Customization at the client side in the IVR provides advertisers with new methods for delivering a campaign with control over the distribution and frequency of unique impressions amongst viewers in a quantifiable way. Information crossing the client/server boundary in either direction may be considered a transaction that can have a fee associated with it.

### [SS8]Purpose of the Invention

With an IVR the user can play their own content such as home movies stored on their own personal computer (and/or other networked devices) as well as content from the Internet such as video clips and feature films. An IVR does not restrict the user to a single content supplier, as is the case with existing satellite and cable television due to the closed delivery mechanism (such as a dedicated satellite, cable or IPTV link).

Content is used here to refer to media that can be displayed on a television such as video, audio and still pictures. Content is typically encoded into a format such as MPEG video, MP3 audio, JPEG pictures and similar standards for storage and transmission via the Internet. Content can be prerecorded for later playback or delivered from live source. An IVR is able to access content from multiple sources on the local network or the Internet. An IVR contains all of the protocols necessary to communicate with the network and has analog/digital interfaces to communicate with a television set or other display device. An IVR is a self-contained appliance bridging the television and the network.

An IVR is able to augment, overlay, insert or superimpose messages to the content that is being played. A message could be an advertisement such as a banner across the screen or a notification such as an alert or alarm. An IVR may also insert traditional advertising by pausing the content and playing one or more television commercials before resuming the original content. In our method the augmentation happens at the client side within the IVR. Augmentation is done by the IVR after the content is received from the network and before it is played on the television. The source of the message is not necessarily limited to a single provider and can be independent from the content that is being played. This has the advantage that messages can be specifically targeted to individual viewers on their television screen. The method of selecting the messages could be done by geographic location or some other means replacing the current system where they are predetermined by the content creator/provider/broadcaster at the server side.

Augmenting Content with Messages and Advertising

Content that is played through an IVR on the television screen can be augmented with further text, video, still images, and/or audio overlay messages from the Internet.

Augmentation of the content is performed as a process internal to the IVR after the content has been retrieved but before it is played on the screen. The source of the message being overlaid can be different from the source of the content being viewed.

The primary uses of overlay messages are to deliver targeted advertising and notifications to the viewer.

Messages can take the form of visual and/or audio information overlaid on the playing content: a banner accompanied by text and images; a simplified map showing directions, animations, embedded video or other effects; an email notification, a bell sound over the audio channel and the like.

More complex examples include the merging of other video, audio, graphics, logos and animations. Augmentations can be placed anywhere in the video and/or audio channels Existing set-top-box type devices can augment a source signal to place overlay messages onto a television screen such as a channel guide. However, the source of a message that is overlaid by a typical set-top-box is limited to those supplied by the cable or satellite service operator. An IVR does not pose such restrictions and is able to augment content from any source with messages from any other unrelated sources from the Internet.

Augmentation by the IVR is a process that is done independently of the content source or supplier. An IVR can augment content with one or more notification messages at the same time from multiple sources.

An IVR is able to identify the content that is being played. This information can be used to track usage and viewing habits. The play history can be sent to anyone via the Internet.

IVR with VFS

Preferred embodiments of the IVR use a Virtual File System (VFS) as a way to organize content stored in multiple locations The IVR provides capability for accessing and modifying the VFS to add or remove content. It provides a means for mapping the location of content stored both locally and remotely as if it were all stored in a single place.

Control of Metadata with IVR

Metadata can be extracted by the IVR from content on the client side in a variety of ways and improved using further information stored either in containers on the client side or containers on the other side of the delivery boundary such as web pages and applications. The IVR is able to query external databases to further improve the metadata. The IVR is able to authenticate with services using a private address book, which can be stored locally in an encrypted memory or accessed from a remote location on the server side.

IVR Interface

The user on the client side can interact with the IVR using a remote control or a web interface. The user interface allows a two way dialogue between the user and the IVR which can lead to new tasks being invoked and having a customized interactive experience which is not limited to a single service provider.

### IVR Embodiments

Embodiments of the present IVR invention may be implemented as a system in a number of different form factors that work with televisions and other devices through a variety of slots, ports and digital buses as well as through more traditional audiovisual connectors. The IVR can be implemented as a separate device or integrated into televisions and other media playing devices in a number of combinations. Further to the form factors, we have provided some examples of realistic embodiments to show how an IVR can be used in a variety of different situations.

### Advantages of the IVR Invention

In contrast to a traditional set-to-box that acts as a relatively simple terminal to a service that is delivered through a dedicated link to a server, in accordance with the present invention an IVR shifts much of the burden from the server side to the client side providing greater flexibility in access to content, and targeted advertising

The present Internet Video Receiver (IVR) invention is a client-side appliance for accessing content from multiple locations including a home network and the Internet The Internet Video Receiver (IVR) can access content and advertising from many different servers on the Internet.

The IVR invention is also able to combine multiple independent sources of content and advertising together at the client side. The relationship between clients and servers is many-to-many. The IVR invention allows the user to select what they want to watch from any source available through an Internet connection. The difference between the traditional approach and a system using an IVR is that anybody can make their content available to watch on television and advertising can be tailored for each individual household or viewer independently from the content supplier.

Having the IVR on the client side, the user is able to choose content from multiple independent suppliers on the Internet while simultaneously allowing advertising from independent suppliers on the other side of the client/server delivery boundary to be merged with content at the client side by the IVR. This provides fully customized services targeted to individual viewers.

### DETAILED DESCRIPTION

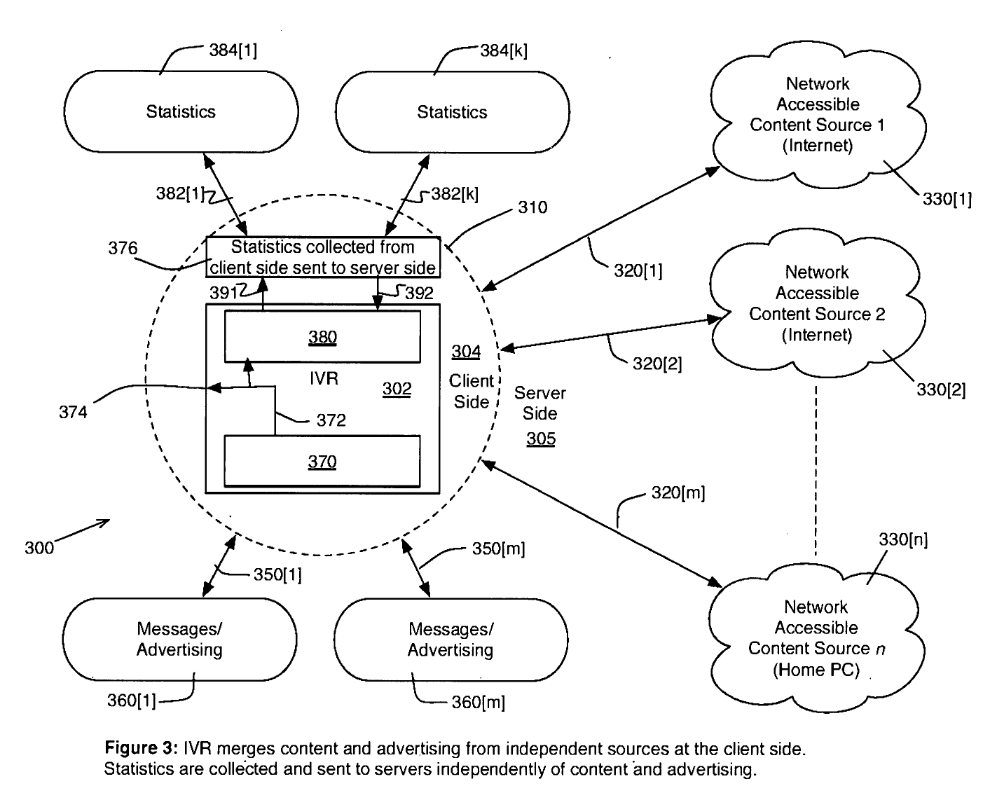

FIG. 3: Model Of Television Delivery System using IVR Invention

FIG. 3 presents a system model 300 incorporating an IVR 302 of the present invention for delivering television. [GMS9]The IVR 302 resides on one side of a communication boundary 310 defined by the IVR and communicates with remote sources and devices located on the other side of the communication boundary 310 by means of physical connections and communication protocols described further below. The IVR side of the boundary is referred to here as the Client side 304.

The other side of the boundary is designated the server side 305.

The IVR locally connects to a TV (not shown) on the Client side to provide media to be displayed and viewed by a local user of the IVR and TV (not shown).

The IVR is enabled to make multiple media content connections to multiple remote Network Access Content Sources. In this example the IVR 302[GMS10] has media content connections 320[1], 320[2], . . . 320[n] that access remote Internet Network Accessible Content Sources 330[1], 330[2], . . . 330[n] respectively.

The IVR 302 is also enabled to make multiple message/advertising media connections to multiple remote Message/Advertising sources. In this example, IVR 302 has message/advertising media connections 350[1] . . . 350[m] to remote Message/Advertising sources 360[1] . . . 360[m], respectively.

The IVR 302 is enabled with a Merging means 370 for merging one or more of selected ones of the Message/Advertising sources 360[1] . . . 360[m], with one or more of selected other ones of the Network Accessible Content Sources 330[1], 330[2], . . . 330[n] and providing locally merged media 372 to a connection 374 to the TV (not shown) for viewing.

A preferred embodiment of the IVR includes a Statistical means 380 for identifying the merged content played by the user, gathering statistics 376 regarding that played content.

The IVR is enabled to make still other multiple connections 382[1] . . . 392[k] to other third parties 384[1] . . . 384[k] who desire to obtain and use the statistics 376 and who are independent of the content and the advertising suppliers. As in the other two examples in FIG. 3, the third parties 384[1] . . . 384[k are also preferably servers for Web sites accessed by standard protocols using IP URLs

The IVR 302 is configured to supply statistics results 391 to Statistics users 384[1 . . . k] in response to requests [GMS11]392[SS12] from them received through connections 382[1−k].

Preferred embodiments of the IVR 302 uses one or more of standard Internet Protocols ) [SS13]such as Hypertext Transfer Protocol (HTTP) or Real-time Streaming Protocol (RTSP) to enable two-way communication over the connections 320, 350, and 382 between the IVR and the content sources 330, the message/advertising sources 360 and the statistics users 384. IPTV protocol is used primarily to retrieve media and messages from the Content sources and to send statistics and other data to the Statistics Users.

The IVR extends the previous model shown in FIG. 2, by adding a second source of content, primarily advertising 360, that is merged at the client side with the other content 330 retrieved by the IVR Advertising can thus be supplied independently of the other retrieved content. The IVR also adds the ability to identify the content being watched using an IVR to gather viewing statistics [SS14]376 and provide them to third parties 384 who are independent of the content and the advertising suppliers,

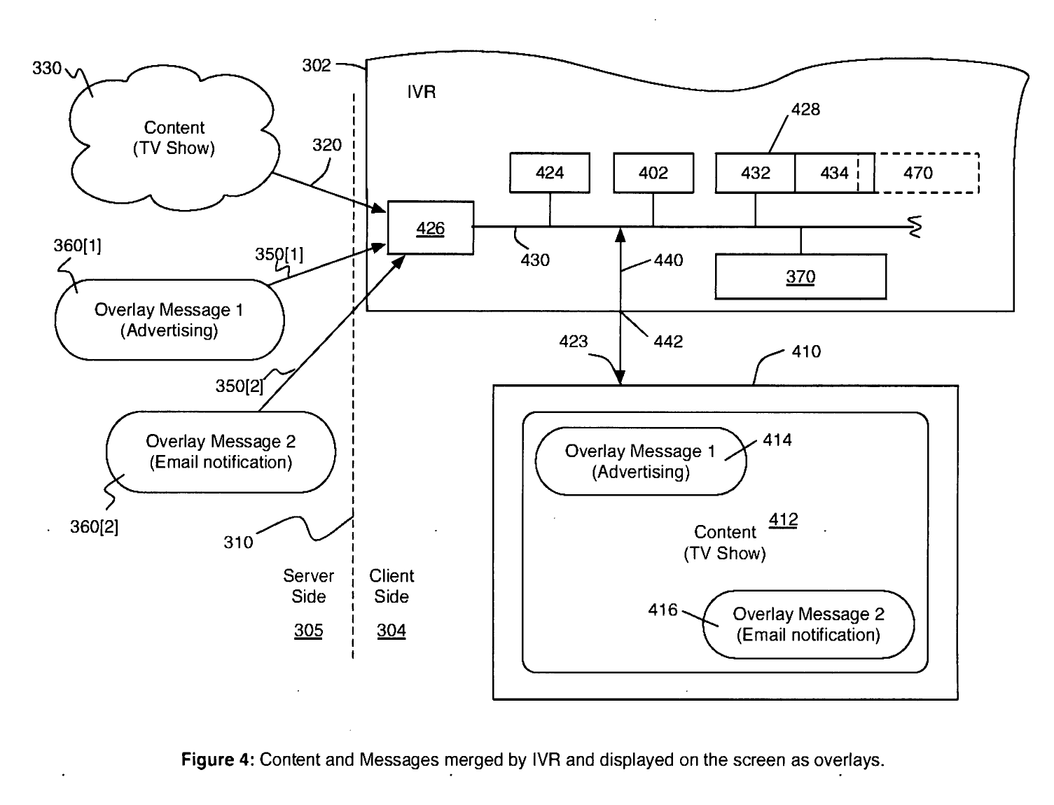

FIG. 4: Merging Independent Content Sources by the IVR

Referring now to FIG. 4 and also to FIG. 3 Content and Messages [GMS15]are merged by an IVR and are displayed on the screen of a connected screen as overlays. A portion[GMS16] of the IVR 302 of FIG. 3 is shown on the client side 304 connected by an media retrieving interface 426 [GMS17]using the standard communication protocols outlined in FIG. 3 through the communication boundary 310 to independent remote sources on the server side 305[SS18]; for example one each of the media content connection 320, the message/advertising media connection 350[1], and an email notification message connection 350[2] communicate respectively to TV show media content 330, advertising content media 360[1] and email message notification content 360[2].

The merging means 370 merges the TV show media 330 with the advertising media content 360 and the email notification media content 360[2] and delivers the merged image through a image data connection 423 to a local TV set 410 for display as the TV image 412 of the TV show media 330 with a first overlay 414 of the advertising message media 360 and a second overly 416 of the email notification message media 360[2].

A hardware implementation of the merging means represented by 370 may be a dedicated DSP, hard-wired logic, dedicated ASIC device or a portion of a larger ASIC or SOC.

There are known algorithms for merging program content digital data with advertising media digital data, whether it is compressed or non-compressed digital data. An example is shown in U.S. patent no. U.S. Pat. No. 6,078,328 to Schumann et al incorporated herein by reference. An optional software implementation of the merging function 370 is depicted by the dashed box 470 representing software such as that described in the above reference.

Implementations of the IVR 302.

The IVR 302 can be implemented with internal components that include one or more of the following: microprocessor(s) and/or dedicated logic 424, a network interface 426 and electronic memory (or memories) 428 communicating over one or more data buses 430. One or more of the electronic memories 428 [GMS19]may be used to store both data 432 and/or program code 434 for execution by processor(s) 424.

Embodiments of an IVR are preferably manufactured using a number of separate Integrated Circuits (ICs) or as a single System on Chip (SoC) implementation where some or all of the components are integrated on a single IC mounted on a compact PC board (not shown). An IVR may also be manufactured as a combination of standard and ASIC ICs and Field Programmable Gate Arrays (FPGAs) interconnected on a PC board.

Embodiments of the IVR can include one or more electronic memories 428. Any of the memories can be partitioned into more than one address spaces. The memories can be volatile and/or non-volatile. There can be any combination of volatile and non-volatile memories partitioned into separate address spaces for storing data 432 and/or program code 434. The electronic memory 428 may be further supplemented or replaced by a disc storage system (not shown).

The inputs/outputs 423, 442 to/from a television 410 and an WR 302 can also be implemented as a wireless link to replace a wire. Examples of such wireless links are standard interfaces such as Ultra Wide Band (UWB), Wireless USB, Bluetooth and similar.

An IVR may have one or more wired/wireless network interfaces, for example, interface 320, 350, 382. The preferred method for connecting to the Internet is over a wireless link (for example Wi-Fi or IEEE 802.11) to a wireless broadband Digital Subscriber Line (DSL), Cable Modem, Terrestrial or similar connection. However if this is not available then a wired connection (for example Ethernet IEEE 802.3) can be used in its place.

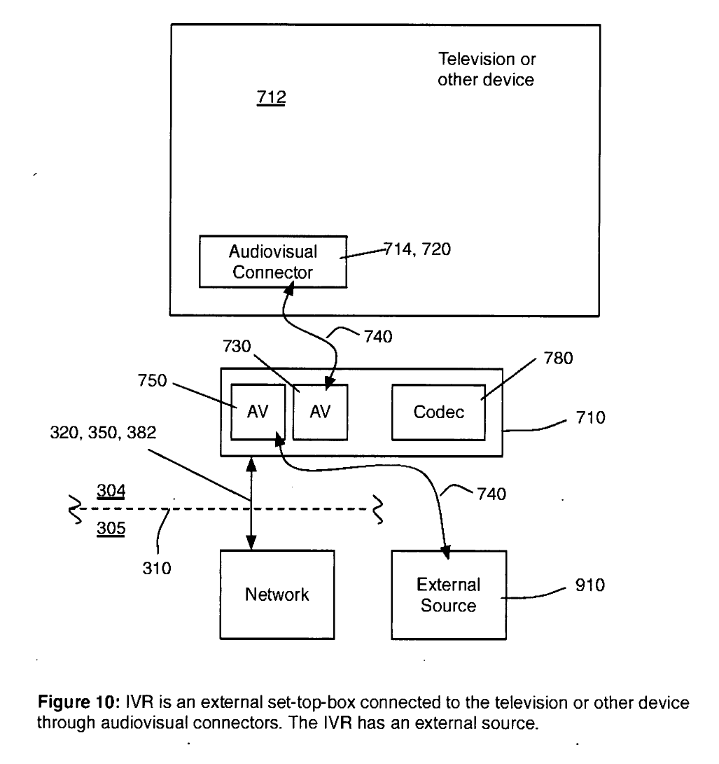

An IVR may have one or more digital interfaces 440, which can be serial or parallel. The digital interface(s) 440 connect the IVR to a data bus i.e., the data bus 430, and/or control lines (not shown) which allows communication with television 410, in the instance where TV 410 is a digital TV, or other digital device. The digital interfaces 440 are implemented with one or more physical connectors 442. Some examples of digital interface/connectors 440/442 are the Universal Serial Bus (USB), Secure Digital (SD) memory card, CableCARD, Peripheral Component Interconnect (PCI), Serial Peripheral Interface (SPI), Inter-Integrated Circuit (I²C) and other similar digital interfaces.

[SS20] In addition to a digital interface 442 to a television 410 or other digital device, an IVR 302 may have one or more audiovisual (AV) inputs and/or outputs (shown in FIG. 7 and FIG. 10) for use with legacy television receivers that do not have digital connector 423. Some examples of audiovisual (AV) input and output connectors are coaxial, composite phono, Syndicat des Constructeurs d'Appareils Radiorécepteurs et Téléviseurs (SCART), High-Definition Multimedia Interface (HDMI) and other similar audiovisual (AV) connectors.

A user interface to the IVR 302 can be a remote control handset 480 used to send commands to an IVR. The handset 480 may communicate with the IVR using infrared or some other wireless link 482. Communication between the remote control 480 and the IVR can be unidirectional or bi-directional, allowing the remote control to receive information from the IVR. Remote control handsets are well known to persons having ordinary skill in the art. The IVR 302 can also be adapted to use a Web user interface (not shown), which is also well known in the art.

IVR Augmenting Content with Messages and Advertising

IVR Augmentation, Display Sequencing.

Content that is played through the IVR of FIG. 4 on the television screen 412 can be augmented with further text, video, still images, and/or audio overlay messages from the Internet.

Augmentation of the content is performed as a process internal to the IVR after the content has been retrieved but before it is played on the screen. The source of the message being overlaid can be different from the source of the content being viewed, e.g., content source 330 and overly sources 360.

Uses of Overlay Messages.

The primary uses of overlay messages are to deliver targeted advertising and notifications to the viewer. Some examples of overlay messages are visual and/or audio notifications such as a sale at the local supermarket, an instant message (such as MSN, Yahoo, AOL and other chat systems), notification of a new email and similar.

Multiple Message Forms.

Messages can take the form of visual and/or audio information overlaid on the playing content. In the example of a sale at the local supermarket, the overlay message 414 may be a banner displayed across the screen with the logo of the store accompanied by text and images describing the items available. There may be a simplified map showing directions to the store from the viewers home, animations, embedded video or other effects to further communicate the message to the viewer. Another example of an overlay message is an email notification 416, the viewer might hear a bell sound over the audio channel and see the name of the sender, subject, time sent and a small fraction of the email text superimposed on the screen while the original content is playing in the background,

More complex examples of a notification might include the merging of other video, audio, graphics, logos and animations. Augmentations can be placed anywhere in the video and/or audio channels meaning that augmentations can appear anywhere on the screen and/or can be heard at any time. Inserting logos into a video is described in U.S. Pat. No. 6,573,945 by Wu et al.

IVR's Unrestricted Augmentation Advantage.

In contrast to existing set-top-box type devices that augment a source signal to place overlay messages onto a television screen such as a channel guide where the source of a message that is overlaid is limited to those supplied by the cable or satellite service operator, an IVR does not pose such restrictions and is able to augment content from any source with messages from any other unrelated sources from the Internet.

The IVR's augmentation process is independent of the content source or supplier. An IVR can augment Content with one or more notification messages at the same time from multiple sources. Augmented messages do not necessarily change when the playing content is changed.

IVR Message Augmentation Methods

There are many different methods known for augmenting content with messages. An IVR may employ but is not limited to the methods described here for augmenting and/or overlaying messages onto content.

Digital media content is typically represented in either the time or frequency domains. For example a time domain encoding of a video can be represented as a series of pixel color values in a two dimensional grid for each frame. A frequency domain representation of the same data could be a series of intensity/magnitude and phase shift values representing how much of the output falls into different frequency bands. The magnitude and phase shift information can be used to reconstruct the original frame in the time domain. An IVR of the present invention may use one or both of these domains to perform content augmentation.

The IVR may use a method for augmenting video with a graphical message in the time domain as in that shown in U.S. Pat. No. 4,907,086 to Truong incorporated herein by reference. U.S. Pat. No. 4,907,086 Truong describes how to copy the source material into a memory such as a frame buffer The overlay can then be superimposed in the frame buffer by changing the color values of individual pixels and converting the augmented output to another format suitable for playback.

Alternatively the IVR may use the method for augmentation of a graphical message onto a video in the case of adding an overlay to an MPEG video as described in U.S. Pat. No. 6,078,328 to Schumann et al., incorporated herein by reference. Schumann et all., describes how to modify the content in the frequency domain. In this method, the augmentation is achieved by modifying the magnitude and phase values to represent a different signal containing the original content with the overlaid message.

The IVR can also apply other transformations to content and messages. These transformations can be computed by the IVR and applied directly to the content and/or messages. Some examples of transformations are convolutions such as blurring, thresholding and color shifting or geometric such as scaling and rotating.

An IVR can alternatively detect solid color regions and static regions in a video between successive frames. By using the method for detecting static regions in a video and implanting a message as given in U.S. Pat. No. 5,491,517 by Kreitman et al. incorporated herein by reference Solid color regions can be identified as a series of identically colored pixels in a frame, for example, the black bars at the top and bottom or sides of a video that has been recorded in a different aspect ratio to the screen it is played on.

Unchanged regions between video frames can be detected by comparing pixel values between frames, for example the background scenery. Another known method for detecting unchanged regions in compressed video such as MPEG is to compare the explicit and predicted motion vectors in intermediate frames.

The IVR can place overlay messages at locations on the screen that change infrequently or are blank. This allows overlay messages to be displayed with minimal interference to the content playing in the background.

Content can be augmented with more than one message at the same time. Content can be filtered through a series of augmentations and transformations to create a composite output. The content may be converted between the spatial and frequency domains with each transformation or augmentation.

Similar methods can be applied to audio, video and pictures over part or all of the sequence of data representing the content that is to be augmented. Content can be augmented and stored in the electronic memory for playback at a later time or it can be augmented at the time of playback.

IR Organizing Content with a Virtual File system

Content can be stored either in the IVR or retrieved from the servers on the network (305 in FIG. 3[SS21]). With regard to Embodiments of an IVR preferably use a hierarchical Virtual File system (VFS) of directories, subdirectories and files to organize content into play lists.

A VFS is a method for organizing files so that they appear to reside in one place when they are actually stored at different locations on the network.

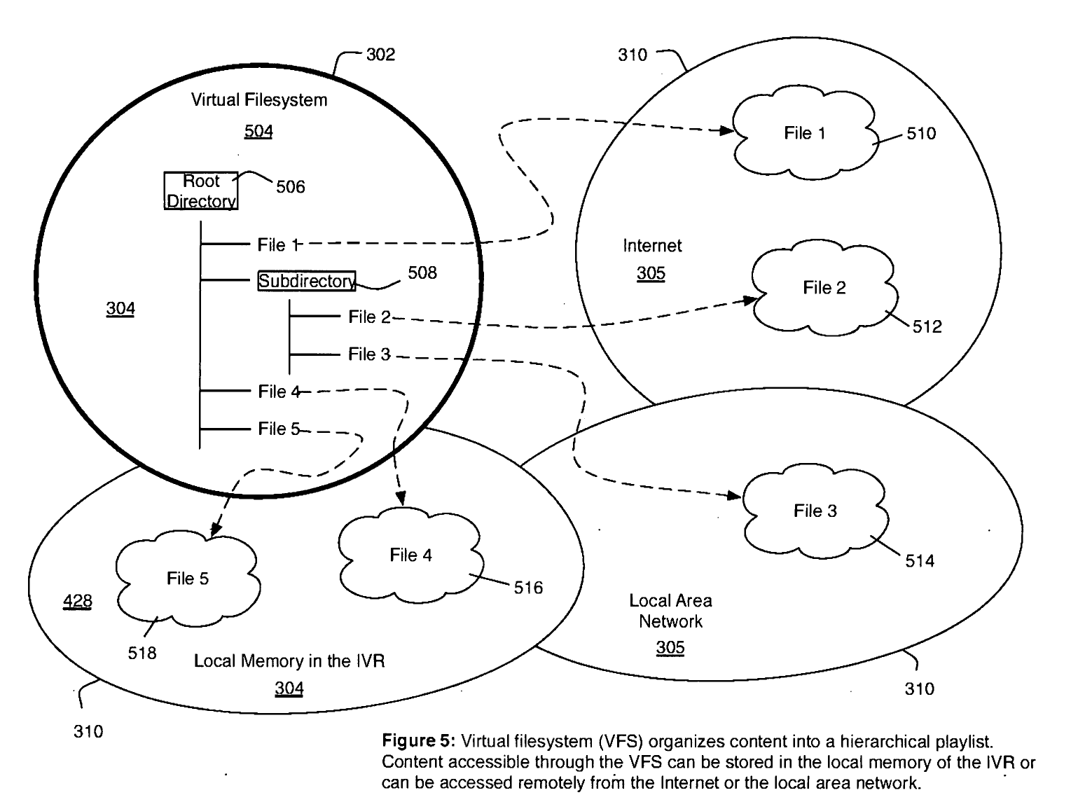

For example, referring now to FIG. 3, FIG. 4 and FIG. 5, a VFS 504 for the IVR 302 may appear for to look like a Microsoft FAT file system, where some of the content ( Root directory 506, subdirectory 508, File 5 File 4) is stored in local memory 428 [SS22]and other content (File 1, File File 3) is stored at one or more remote locations 510, 512 (Internet network), 514.(local network) To the user, it appears as if all of the content is stored and accessed from a single place. Some or all of the files in a VFS may be fabricated by the IVR, for example a video of a blank screen, pattern or other content that can be rendered (not shown).

A VFS is similar to the idea of a translucent file system presented by Hendricks et al. in U.S. Pat. No. 5,313,646. The idea of a VFS is further explained by Kish in U.S. Pat. No. 5,603,019. both incorporated herein by reference.

A file can refer to content that is stored either in the electronic memory 428 [SS23]of the IVR or at another location 514 on a local area network on the client side 304 or the Internet on the server side 305. If the file that has been selected for playback already resides in the electronic memory of the IVR, playback commences. If the file does not reside in the electronic memory of the IVR, but has a known location on a local area network or the Internet, the IVR retrieves the file for playback. Playback may begin before the entire file has been retrieved. Content retrieved from the network can be viewed on the television screen immediately or stored for later playback.

The source of the content can be changed at any time or retrieved in parallel from multiple locations simultaneously. For example, if the content is stored at more than one network location, the IVR may use any combination of sources to retrieve the complete sequence of data. The IVR may also change the content being played from one source to another, for example, to present a news bulletin or television commercials in the middle of playing content.

The encoding scheme of the retrieved file may be converted by well known means (not shown) to an alternate representation (transcoded), for example from Flash Video (FLV) that is used by Internet video services such as Youtube to MPEG-4 or H.264 standards used by high definition television

A virtual file system is well known method to organize content stored in multiple locations. The IVR preferably uses these methods for accessing and modifying the virtual file system to add or remove content. the IVR uses the VFS for mapping the location of content stored both locally and remotely as if it were all stored in a single place.

Embodiments of the IVR are enabled to extract Metadata content in a variety of ways and improved using further information stored in containers such as web pages and applications. The IVR is able to query external databases to further improve the metadata. The IVR is able to authenticate with services using a private address book that can be stored locally in an encrypted memory or accessed from a remote location on the server side. The user can interact with the IVR using a remote control or a web interface. The user interface allows a two way dialogue between the user and the IVR which can lead to new tasks being invoked and having a customized interactive experience which is not limited to a single service provider.

IVR Accessing the Virtual File System

The user is able to navigate the VFS to choose what content is to be played. The user can request to play, pause, fast-forward and rewind the content. An IVR supplies content to the television based on the requests it receives from the user.

The VFS represents an electronic memory that appears as single flat address space. A request is typically a read or write operation. A read request takes a memory address and returns some data stored at that corresponding address. A write request takes a memory address and some data that is written to the corresponding address.

When a read/write request is made to the IVR, it supplies or stores the appropriate data for the address that is given. Playing some content that appears to be stored on the IVR may be performed as the following steps:

1. A request is made to the IVR to read the VFS.

2. The IVR replies with a series of bytes corresponding to the VFS

3. A search is initiated for the name of the content that is to be played and finds the corresponding memory address where the content is stored.

4. Another read request is made to the IVR to supply the series of bytes from the start address to the end address for the file/content.

5. The file/content is returned as a stream of bytes that can be played on the television.

The actual bytes that are supplied by the IVR may come via the network interface 426 or from an internal memory 428. An IVR maintains a translation table that maps the addresses in the VFS as pointers to their corresponding true locations stored either in the IVR or at some other location. If the location is remote, then the content is retrieved over the network using a protocol such as Hypertext Transfer Protocol (HTTP) or Realtime Streaming Protocol (RTSP).

If the content is being accessed from a remote location over the network, the IVR may choose to buffer part/all of the file to ensure that there are no interruptions in playback. This method of retrieving multimedia content is more commonly known as streaming. An IVR may also choose and adjust the rate at which it retrieves the content over the network. U.S. Pat. No. 4,887,204 to Johnson et al incorporated herein by reference describes a method for accessing remote files for the purposes of both reading and writing. An IVR accesses remote files for the purposes of reading. Content can also be paused, played forward at higher speed (fast-forward) or played backwards (rewound). In each case, the operation corresponds to a set of read/write operations. Fast-forwarding content may generate a sequence of read operations that are staggered or requested at a faster rate. A rewind request may correspond to a sequence of read requests that are staggered or at a faster rate with addresses leading toward the start of the file. If the file being accessed is stored remotely, these forward/rewind operations correspond to retrieving different parts of the file at different rates.

IVR Updating the Virtual File System

The virtual file system representing the available media content can be modified by the user via a remote control handset or a web interface served by an IVR. The user accesses the web interface using a web browser on a separate computer. An IVR can be instructed by the remote control or web interface to do one or more of the following tasks:
Add/remove files to the electronic memory of the IVR for later playback.
Add/remove network locations for files that will be retrieved on-demand.
Add/remove subscriptions to services such as Really Simple Syndication (RSS) feeds (for example video podcasts from the Internet). In this case, an IVR will periodically check the subscription for new items and present them in the file system as they become available.

The result is that content can be added or removed from the file system. The new content may reside in the electronic memory of the IVR or at another location on a network. New items can automatically be pushed to the IVR via a subscription causing the file system to be updated and optionally retrieving and storing new content in the electronic memory for later playback.

### Alternate Embodiments

The IVR invention may be implemented as a system in a number of different form factors that work with televisions and other devices through a variety of slots, ports and digital buses as well as through more traditional audiovisual connectors. Alternately, the IVR can be implemented as a separate device or integrated into televisions and other media playing devices in a number of combinations. Examples of various implementations of the present IVR invention, presented below, provide some realistic examples how an IVR embodied with different Form Factors can be used in a variety of different situations.

IVR Retrieving Source Independent Content and Metadata from Services on the Internet

Videos and other content can originate from a number of sources encoded in different formats. A video can be stored as a file containing metadata encoded into it including but not limited to the title, copyright owner and other information that is used to identify the origins of the content. Other sources of video may be embedded on a web page for example as Flash FLV videos on websites such as Youtube.

If the video is sourced from an embedded applet on a web page, the IVR can extract the location of the video file as a Uniform Resource Locator (URL) in a number of ways. The URL of the video may be embedded in the Hypertext Markup Language (HTML) source of the web page or an embedded application that is on the page. In the case that the URL is embedded in an application it is possible to execute the program and discover the source of the video. There may also be a third party database, which can be queried to determine the origins of a video given the URL or other identifier of a web page.

Other metadata such as the title can be extracted from information in the web page containing the embedded video. If there is no metadata available, the IVR can use the name or URL of the content as an identifier. Further metadata can be obtained by using the known information as a search query to a database that has more complete information. As an example, the title of a video can be used to find further information on another service such as the Internet Movie Database (imdb.com) to discover the year of release, a synopsis of the content, the names of the actors, director and other useful information about a film or TV show being played.

Existing television services rely on the broadcaster to prepare this information and send it with the content to the television receiver. An IVR can gather information from multiple sources on the Internet for content that is provided by third parties.

Metadata can be extracted at anytime and used to enhance content titles in the VFS. The metadata may be also be presented to the user as a message on the screen. The metadata associated with content can be stored for later usage and also sent to anyone on the Internet.

Transaction Monetization by the IVR

Referring again to FIG. 3 and FIG. 4 the IVR 302 of the present invention allows content from multiple independent sources, e.g., content 330 and notification messages/advertising 360 from the server side 305 to be merged 370 at the client side. One key feature of the present invention is locating the merging process on the client side, which allows much greater customization to the individual viewer. Furthermore, statistics on playback media merged by 370 when delivered to the TV 410 through connections 423/442 to be gathered at the client side 304 and sent to independent users 384 on the server side.305

The IVR of the present invention can be used to send and receive monetary payments by keeping an account either in local storage 428 or accessible remotely via the Internet. Money can be paid into the account in advance to maintain a credit and/or spent from the account creating a debit. A fee can be charged for each transaction of information crossing the client/server boundary in either direction. This is a different business method to existing methods for selling services through a television because the transaction is negotiated between the client and the server without necessarily requiring an intermediate broker to act as a conduit for the transaction (for example a television service provider). Some examples for monetization from transactions crossing the client/server boundary are charges levied to:
the user of the IVR for accessing a single item of content
an advertiser for each time their advertisement is rendered by an IVR
the receiver of statistical information
the user of the IVR for receiving recommendations based on their usage history
the user of the IVR for receiving a notification (for example, an email or an instant message) from a server
the sender of a notification message to an individual user (for example a discount coupon that is displayed to the viewer)
the user of the IVR giving a charitable donation in response to a message

IVR with Optional Codec for Legacy Analog TV

For use with legacy analog TVs or other analog input device 712, an analog embodiment of the IVR may also optionally contain an Encoder/Decoder (Codec). Referring to FIG. 7 in addition to FIG. 3, and FIG. 4[GMS24], an IVR set-top-box (STB) 710 implementation of the present IVR invention is shown connected to an analog input device 712, in particular an analog input TV set, on the client side 304 of the communication boundary 310. Analog devices like legacy TV 712 and other similar analog input devices are equipped with an analog Audiovisual connector 714 such as an antenna input, RGB connector and the like, for playing analog media.

The IVR 710 also includes the digital interface 426 [GMS25]and the merging means 370 shown in FIG. 3 for retrieving and merging digital media content 320, 350, received from the Internet and local area networks of FIG. 3 by mean of a digital connection 722 from the network to the digital interface 426 [GMS26]in FIG. 4[GMS27].

IVR STB 710 includes an optional Codec 720 for compressing/decompressing digital media content.320, 350, retrieved from the Internet or local area network on the server side 305 for delivery in a format compatible with device 712.

When the IVR 710 of FIG. 7 contains a Codec 720 it may also optionally contain a Digital to Analog Converter (DAC) (not shown) [GMS28]for converting merged digital media 374 like that produced by the IVR 302 in FIG. 3, into an analog output 740 delivered to the A/V connector 714 of the analog TV 712 (or other analog device) for playing on the device 712.

IVR with Optional A/D Converter for Analog Input Signals

With reference now to FIG. 10 in addition to FIG. 3 and FIG. 7, the IVR STB 710 has analog input 742 connected to an external source 744 having an analog output 746. The IVR STB 710 in FIG. 10 includes an A/D converter 750 that receives the analog input 742 and converts it to digital format (not shown) for further processing by digital portions of the IVR 710 described elsewhere herein; i.e., the Codec 720, the merging function 370, etc.[GMS29] This enables the IVR STB 710 to process analog input media in digital form before conversion back to analog format 740 for the TV 712 or other analog input device.

IVR Authentication with [GMS30]Services on the Internet

Some content available on the Internet requires authentication before it can be accessed, for example fee based subscription services. An IVR is able to communicate with such services and extract the relevant content for playing.

An IVR can store usernames and passwords in an address book either in a local memory or remotely on an Internet server. New authentication credentials can be added to the address book by the user via a remote control or web interface. The address book can be stored in an encrypted format. Usernames and passwords can only be seen by the user and by the corresponding service providers issueing passwords and are not accessible to unauthorized third parties.

IVR History Logging

An IVR is able to track playback history for the purposes of gathering statistics about the popularity of content being played from the Internet. The statistics gathered by an WR are sent to an Internet server where they can be aggregated and used to help further suggest content and messages that can be targeted to individuals and supplied as subscriptions [GMS31]back to the viewer.

Statistics are gathered by identifying each playable item in the file system by name or URL. A count is incremented for each time an item is played. An IVR may also record other information about the content that has been played, for example:
Start date and time
Duration of playback
Geographical location of playback
Size, compression ratio and/or bit-rate of the file
Number of buffer underflows when content is streamed from the network
Other metadata associated with the content

The geographical location of an IVR can be used to target messages by location, for example news items or advertising that are relevant to a particular locality. The geographic location of an IVR can be discovered from the assigned network address, for example an Internet Protocol (IP) address that corresponds to a place. Sometimes IP addresses can be assigned to the wrong geographic area in which case the location may be made more precise by requesting the user to add further information such as:
Zip/postal code
Telephone area code
Specifying the street address

IVR User Interface

The user can have an interactive dialogue with the IVR to do more than choose what content to play. Interactivity between the user and the IVR can be performed through a remote control or via a web interface.

An IVR can receive commands such as play, pause, forward and rewind. These controls are used to control the playback of content. They can also be used to navigate the VFS. When a file is chosen to be played, an IVR can interpret the read request and perform further operations beyond just playing the content, for example, playing a file can send a notification with the title of the content to all of the users friends.

The VFS can also be used to present a questionnaire to the user. Each question can be represented as a directory name with a number of possible answers as files or subdirectories of the parent directory. The user can answer the questionnaire by navigating the directory tree and playing the files that represent the answers they wish to submit. For example, when the user begins to navigate the VFS, they may be presented with a root directory named “do you prefer” containing two files named “documentary” and “drama”. Depending on the file that is chosen, an IVR may then automatically populate the VFS with subscriptions to content that has a bias towards either documentary or drama.

Overlay messages can be used to present questions to the user. For example, an overlay message may appear on the screen with the question “do you like this show?” The user may answer the question with the playback controls by pressing forward for “yes” or pause for “no”. The controls may also be used to give a show a satisfaction rating, for example the IVR may present the user with a message “rate this show out of five stars”. The user may use the forward and rewind buttons to signify incrementally a number from zero to five.

The user can also interact with an IVR through a web interface. An IVR may contain a web server that is capable of generating web pages and web forms. Alternatively the web server may be located elsewhere on the Internet and may send commands to the IVR remotely. This allows tasks such as configuring the IVR or preparing a playlist from a remote location. Web interfaces can be accessed from a web browser on a personal computer or other web enabled device.

IVR Implementation Details

The internal components of an IVR include one or more of the following: microprocessor or dedicated. logic, network interface and electronic memory. One or more of the electronic memories 428 may be used to store both data and/or programs for execution by the processor(s) 424.

An IVR can be manufactured using a number of separate Integrated Circuits (ICs) or as a System on Chip (SoC) implementation where some or all of the components are integrated on a single IC. An IVR may also be manufactured as a combination of ICs and Field Programmable Gate Arrays (FPGAs).

There can be one or more electronic memories. Any of the memories can be partitioned into more than one address spaces. The memories can be volatile and/or non-volatile. There can be any combination of volatile and non-volatile memories partitioned into separate address spaces for storing programs and/or data. The electronic memory may be further supplemented or replaced by a disc storage system.

An IVR may have one or more wired/wireless network interfaces.426 The preferred method for connecting to the Internet is over a wireless link (for example Wi-Fi or IEEE 802.11) to a wireless broadband Digital Subscriber Line (DSL), Cable Modem, Terrestrial or similar connection.

However if this is not available then a wired connection (for example Ethernet IEEE 802.3) can be used in its place.

An IVR may have one or more digital interfaces, which can be serial or parallel. The digital interface(s) connect the IVR to a data bus and/or control lines which allows communication with a television or other device. The digital interface can be implemented as one or more physical connectors. Some examples of a digital interface are the Universal Serial Bus (USB), Secure Digital (SD) memory card, CableCARD, Peripheral Component Interconnect (PCI), Serial Peripheral Interface (SPI), Inter-Integrated Circuit (I²C) and other similar digital interfaces.

An IVR may also have one or more analog/digital audiovisual inputs and/or outputs. The inputs allow for external content source such as terrestrial, cable, satellite or similar content to be fed into the IVR. The outputs allow an IVR to be connected to a television or other device. Some examples of the input and output connectors are coaxial, composite phono, Syndicat des Constructeurs d'Appareils Radiorécepteurs et Téléviseurs (SCART), High-Definition Multimedia Interface (HDMI) and other similar audiovisual connectors.

An IVR may also optionally contain an Encodor/Decoder (Codec) for compressing/decompressing digital media content. If the IVR contains a codec it may also optionally contain an Analog to Digital Converter (ADC) and/or a Digital to Analog Converter (DAC). The ADC and/or DACs may be used to send and/or receive a signal to/from an external device such as a television or a Video Cassette Recorder (VCR).

The inputs/outputs to/from an IVR and a television can also be implemented as a wireless link to replace a wire. Examples of such wireless interfaces are Ultra Wide Band (UWB), Wireless USB, Bluetooth and similar.

An optional remote control handset can be used to send commands to an IVR. The remote control handset may communicate with the IVR using infrared or some other wireless link.

Communication between the remote control and the IVR can be unidirectional or bi-directional, allowing the remote control to receive information from the IVR.

### IVR Form Factors and Embodiments

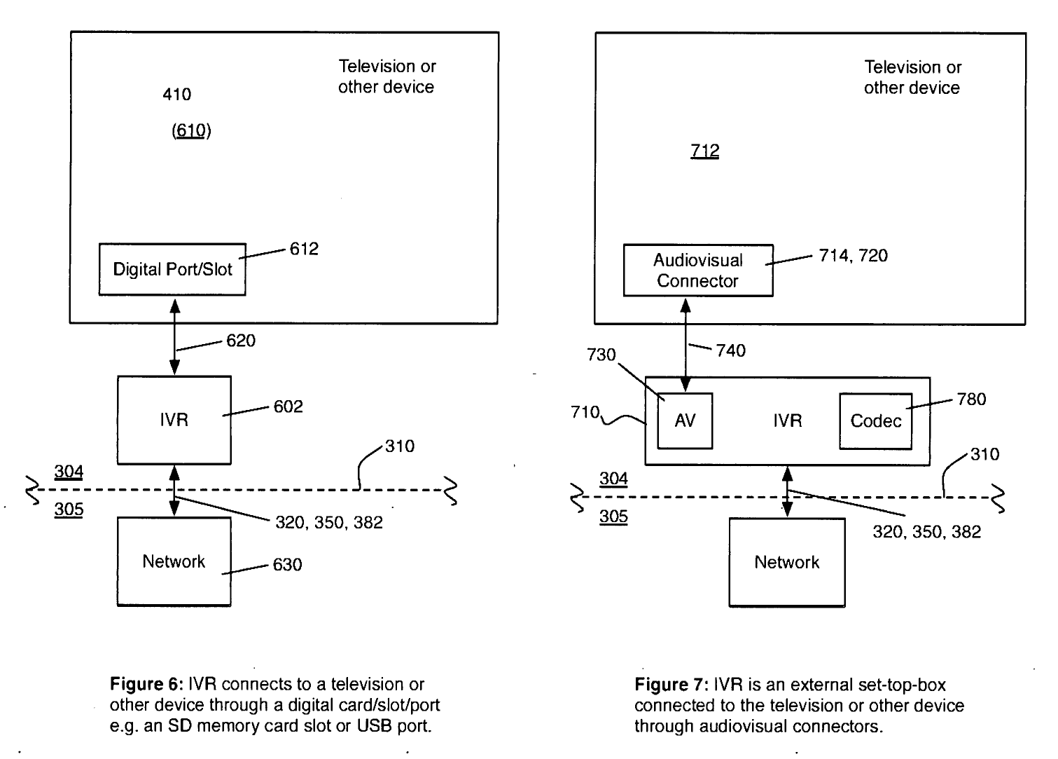

An IVR can be implemented in the following form factors, FIGS. 6-10:

Form Factor 1:

Referring to FIG. 6 along with FIG. 3, FIG. 4 and FIG. 5 there is depicted a preferred embodiment 602 of the IVR of the present invention configured to be used solely with a digital host device such as the digital television 410 of FIG. 4 (or optionally another digital host device 610) that has a digital port/slot 612 incorporating a digital interface 620 such as the Universal Serial Bus (USB) port, Secure Digital (SD) card slot, CableCARD slot or similar digital interface that enables digital data content (e.g., media 330, 360) transfer compatible with the IVR VFS 502 shown in FIG. 5. The digital host device, e.g., the TV 410 (or optional digital host 610) is responsible for decoding the digital data content communicated from the IVR 302 by the interface 620, as well as controlling functions such as play, pause, forward and rewind initiated by a user interface, such as the remote control 480 of FIG. 4. In this embodiment, the host device uses the IVR to retrieve and play content. The host is responsible for decoding the content as well as controlling functions such as play, pause, forward and rewind. The IVR 602 of FIG. 6 is able to take advantage of the considerable decoding and controlling resources of found in the digital host 410 (610) making it potentially smaller and cheaper than a set-top-box. As in other implementations the IVR 602 is located on the client side of communication boundary 310 and communicates with Internet or local area network sources 330, 360, on the server side 305 by wired or wireless interfaces such as 320, 350 and 382 of FIG. 3.

Form Factor 2:[SS32]

FIG. 7 in combination with FIG. 5 depicts an IVR 710 of the present invention in the form of a set-top-box adapted for use with a legacy analog television, DVD player, music system or similar device 712 with audiovisual (AV) input interface 720. The IVR 710 is adapted to be compatible with device 712 by using an output signal 730 connector [GMS33]complementary with device 710 analog input connectors 720.

In this embodiment, the IVR 710 is responsible for merging and decoding content from files retrieved by the VFS 504 from the internet or local area network on the server side 305, into an analog output signal 740 delivered by using the analog interface 730 that can be received by the analog input device 710 television or other device. In this embodiment, the IVR is responsible for controlling functions such as play, pause, forward and rewind. The IVR 710 is also is equipped with a codec 780 for decoding the content retrieved. The IVR 710 may also include a DAC or A/D converter (not shown) as required by the AV connector 730.[GMS34]

Form Factor 3:

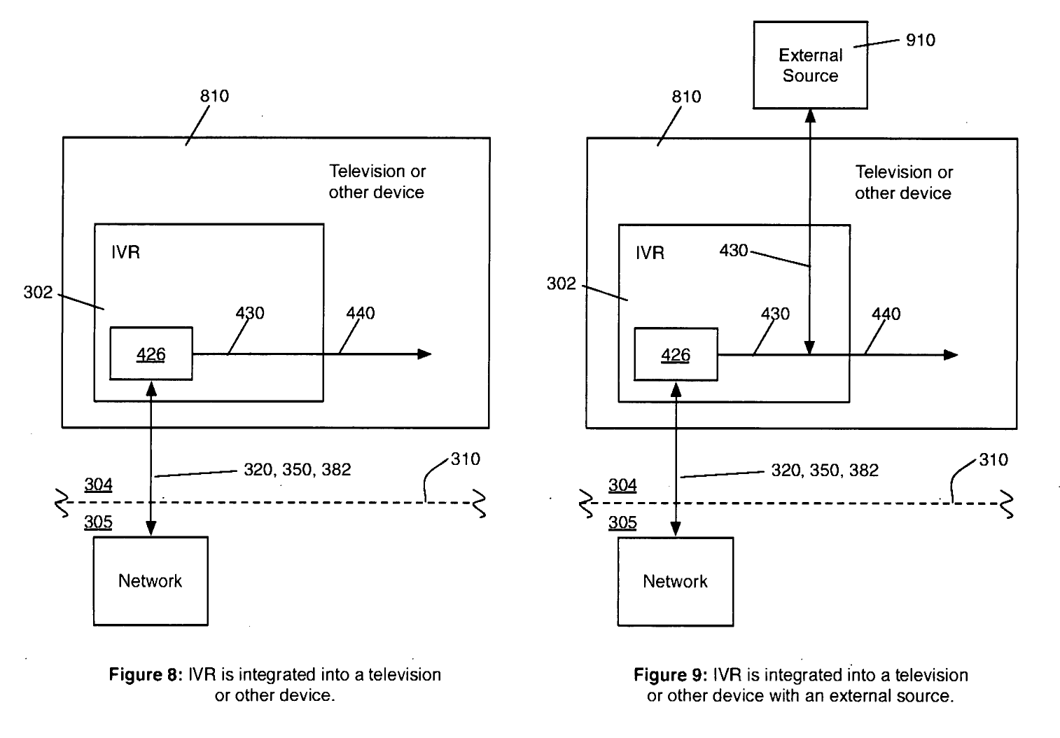

Referring now to FIG. 8[GMS35] in combination with FIG. 4, FIG. 8 depicts an IVR such as the IVR 302 of FIG. 4 when integrated into a television or other device 810. In this embodiment, the integrated IVR 302 extends the capabilities of the television or other device 810 via an internal bus and control lines 430 to an internal shared digital interface 440 with the television.

Form Factor 4:

Referring now to FIG. 9 in combination with FIG. 4, FIG. 9 depicts the integrated IVR 302 as in Form Factor 3 where there is an additional external source of content 810 such as a terrestrial, satellite, cable, IPTV and similar[GMS36]. Again, as in FIG. 8, , the integrated IVR 302 extends the capabilities of the television or other device 810 via an internal bus and control lines 430 to an internal shared digital interface 440 with the television. In this form factor, the IVR can augment the external source of content 910 with overlay messages and advertising. In this form factor, the IVR may record content from the external source to an electronic memory for later playback.

Form Factor 5:

Referring now to FIG. 10 in combination with FIG. 7 and FIG. 9, FIG. 10 depicts an IVR 710 [GMS37]as in Form Factor 2 where there is an additional external source of content 910 such as a terrestrial, satellite, cable, IPTV and similar. The IVR is equipped with an audiovisual connector 750 for input from an additional external source of content 810 such as a terrestrial, satellite, cable, IPTV and similar. In this form factor, the IVR can augment the external source of content with overlay messages and advertising. In this form factor, the IVR may record content from the external source to an electronic memory for later playback.

### IVR Embodiment Examples

### Embodiment 1

Packaged in a Secure Digital (SD) memory card. The IVR has the physical appearance, mechanical properties and external digital interface of an SD memory card. The IVR can be used with any host device that is able to read an SD memory card. Examples of host devices are televisions, DVD players, cell/mobile/smart phones, MP3 players, media players, laptop computers, desktop computers and other personal entertainment devices that are able to play content from an SD memory card.

The IVR presents the Virtual File system (VFS) in a suitable format (for example Microsoft FAT) to the host playback device via the digital interface. To the host device it appears as if the WR is an ordinary SD memory card storing media content.

This embodiment of the IVR may also implement the Secure Digital Input Output (SDIO) protocol to communicate with the host device.

This embodiment has the properties of Form Factor 1 and is represented in FIG. 6.

### Embodiment 2

With a Universal Serial Bus (USB) connector the IVR can be used with any host device that is able to read from a USB mass storage device. Examples of host devices are televisions, DVD players, laptop computers, desktop computers and other personal entertainment devices that are able to play content from a USB mass storage device.

The IVR presents the Virtual File system (VFS) in a suitable format (for example Microsoft FAT) to the host playback device via the digital interface. To the host device it appears as if the IVR is an ordinary USB mass storage device storing media content.

The physical appearance of this embodiment is similar to a USB key/thumb drive where the whole IVR is plugged into a USB socket. This embodiment can also be packaged in a larger casing where an extension cable is used to connect the IVR to the USB port on the host device.

This embodiment has the properties of Form Factor 1 and is represented in FIG. 6.

### Embodiment 3

A set-top-box. The IVR provides functionality in a self-contained separate unit. The IVR has a codec to decompress the content into a signal that can be received by a television. The IVR is connected to the television through an audiovisual interconnect such as analog composite, digital HDMI or similar.

It is the task of the IVR to provide a suitable user interface and controls for navigating the VFS and to control playback.

This embodiment has the properties of Form Factor 2 and is represented in FIG. 7.

### Embodiment 4

Integrated into a television. In this form, the IVR may be one or more ICs or SoCs integrated into a television set. The integration can be done at the time of manufacture or as an installable upgrade.

This form of the IVR may have an internal codec or use/share a separate external codec to decompress content.

This embodiment has the properties of Form Factor 3 and is represented in FIG. 8.

### Embodiment 5

Integrated into a disc based media player as in Embodiment 4 but integrated into a DVD/HD-DVD/Blu-ray or similar player.

This embodiment has the properties of Form Factor 3 and is represented in FIG. 8.

### Embodiment 6

Integrated into a personal media player as in Embodiment 4 but integrated into a device such as cell/mobile/smart phone, Walkman, IPod or other portable/battery powered device capable of playing content.

This embodiment has the properties of Form Factor 3 and is represented in FIG. 8.

### Embodiment 7

Integrated into a television with an external source. As in Embodiment 4 where there is an additional external source such as a terrestrial, satellite, cable and similar broadcast. An external source could also be a VCR, DVD/HD-DVD/Blu-ray, camcorder or similar. In this embodiment the IVR is able to add overlay messages to the external source before it is displayed. In this embodiment the IVR is able to identify that there is an external source of content.

This embodiment has the properties of Form Factor 4 and is represented in FIG. 9.

### Embodiment 8

As a set-top-box with an external source. As in Embodiment 3 where there is an additional external source such as a terrestrial, satellite, cable or similar broadcast. An external source could also be a VCR, DVD/HD-DVD/Blu-ray, camcorder or similar. In this embodiment the IVR is able to add overlay messages to the external source before it is displayed. In this embodiment the IVR is able to identify that there is an external source of content.

This embodiment has the properties of Form Factor 5 and is represented in FIG. 10.

### Embodiment 9

Integrated into a disc based media player with an external source. As in Embodiment 5 where there is an additional external source such as a terrestrial, satellite, cable or similar broadcast. An external source could also be a VCR, camcorder or similar. In this embodiment the IVR is able to add overlay messages to the external source before it is displayed. In this embodiment the IVR is able to identify that there is an external source of content.

This embodiment has the properties of Form Factor 5 and is represented in FIG. 10.

### Embodiment 10

As an expansion for a personal computer or game console. Some game consoles and personal computers (known as media centers) are used to play content on a television. This embodiment of the IVR takes the form of a peripheral to extend the functionality of a computer or game console with dedicated IVR capabilities.

This embodiment can be a separate expansion card with a PCI or similar interface that is plugged into an expansion slot/port. This embodiment can be integrated directly onto the motherboard of a personal computer or game console.

This embodiment has the properties of Form Factor 3 and is represented in FIG. 7.

### Embodiment 11

A general-purpose computer dedicated to the purpose of an IVR. Any computer such as a personal computer, game console, embedded system or device dedicated to the purpose of delivering the capabilities of an IVR to a television or other display device.

In this embodiment a computer is dedicated to the single purpose of merging content with advertising and/or gathering viewing statistics.

This includes computers used primarily as an IVR or computers used for part of the time as a dedicated IVR.

This embodiment can have the properties of Form Factors 1-5 and can be represented in any of FIGS. 6-10 or otherwise.

The Internet Video Receiver (IVR) invention has been described as an appliance for accessing content from multiple locations including a home network and the Internet. Existing methods for delivering content to a television limit the user to a single supplier/server because of the closed architecture of existing set-top-boxes and media centers. With an IVR the user is able to choose content from multiple independent suppliers on the Internet.

A major feature of the present invention is to move control over the sources of content from the server side to the client side allowing the user to choose content from multiple independent sources accessible through the network. A further capability of the present invention is to merge content with advertising, messages and notifications from other independent server side sources at the client side, enabling a customized and unique services for each viewer. Statistics are gathered at the client side for viewed content and sent to one or more independent destinations on the server side. The statistics can be used to provide new advertising, messages and notifications to the client side. The ability to deliver custom advertising to an IVR allows for advertisers to delivera campaign with control over the distribution and frequency of unique impressions amongst viewers in a quantifiable way. Information crossing the client/server boundary in either direction is considered a transaction, which can have a fee, associated with it.

The IVR preferably uses a virtual file system as a way to organize content stored in multiple locations. The [GMS38]IVR enables methods for accessing and modifying the virtual file system to add or remove content. The IVR also enables authorized entities (the user, a third party web server and the like control of a method for mapping the location of content stored both locally and remotely as if it were all stored in a single place.

Metadata can be extracted by the IVR from content accessed, merged and displayed in a variety of ways. The extracted metadata can then be improved using further information stored in containers such as web pages and applications. The IVR is able to query external databases to further improve the metadata. The IVR is able to authenticate with services using a private address book, which can be stored locally in an encrypted memory or accessed from a remote location on the server side. The user can interact with the IVR using a remote control or a web interface. The user interface allows a two way dialogue between the user and the IVR which can lead to new tasks being invoked and having a customized interactive experience which is not limited to a single service provider. Embodiments of the IVR may be implemented as a system in a number of different form factors that work with televisions and other devices through a variety of slots, ports and digital buses as well as through more traditional audiovisual connectors. The IVR can be implemented as a separate device or integrated into televisions and other media playing devices in a number of combinations. Some realistic examples of form factor embodiments have been presented to show how an IVR can be used in a variety of different situations.

Knowledgeable practitioners of the art will appreciate that the scope of the IVR invention is not limited to the embodiments; form factors, interfaces, connections, and operating functions described above, but are limited only by the claims herein.

We claim:

1. An Internet Video Receiver (IVR) apparatus disposed on a one (Client) side of a communication boundary, said apparatus comprising:
a) a TV media interface configured to interface with a digital [GMS1]connection common to a plurality of local digital devices disposed on the Client side of said boundary, said local digital devices comprising:
i) a digital television display;
ii) a DVD player;
iii) an intermediate device that has a separate digital port adapted to connect to a separate digital device;
b) A digital network interface adapted to retrieve multiple items of digital media content from any of a plurality of independent sources, said independent sources comprising:
i) independent Server side sources, said independent Server side sources disposed on the opposite (Server) side of said communication boundary, said independent Server side sources comprising:
(i) one or more digital networks, comprising:
1. the Internet;
2. one or more WANs;
3. one or more LANs;
4. one or more computers each having a digital connection compatible with [GMS2]said network interface[GMS3];
ii) independent Client side sources, wherein said independent Client sides sources comprise:
(1) local sources stored in an memory disposed within said IVR;
(2) local sources stored on local area networks disposed on said client side of said boundary;
c) a digital media merging means for merging at least two of selected ones of said retrieved digital media content items into a merged digital output item and delivering said merged digital output item through said TV media interface;.
d) A Virtual File System (VFS) means for accessing, retrieving and storing said retrieved multiple digital content items in a VFS format, wherein said VFS is compatible with said independent Server side sources, and further, wherein said VFS is compatible with said TV media interface;
e) A Function Control[GMS4] means for controlling IVR functions, said IVR functions comprising:
(1) Selection of said digital media content items to be retrieved from said independent Server side sources,
(2) Selection of said digital media content items to be merged by said digital media merging means;
(3) Selection of said merged digital output to be delivered;
(4) Selection of recipients to receive said delivery of said merged digital output;
f) Whereby two independent types of digital media content from at least two of said independent sources can be independently retrieved, jointly merged and delivered to a connected TV through said TV media interface.

2. The IVR as set forth in claim 1, including;
a) Statistics means for monitoring and gathering playback statistics related to digital media content delivered to said TV media interface.
b) Communication from said Statistics means to said network interface, wherein connection is made available to said independent Server side sources for exchanging requests and responses to and from the IVR;
i) Wherein said requests and responses include requests from and responses to said independent Server side sources including Statistics User servers
ii) Wherein said Statistics means delivers statistical information derived from said playback statistics upon request from selected ones of said Statistics User servers.

3. The IVR as set forth in claim 1, wherein said IVR enables selection and merging of at least two different ones of said independent server side digital media content for delivery of said merged digital media to said digital TV interface.

4. The IVR as set forth in claim 3, wherein said independent server side digital media content server side sources comprise:
a) media content providers;
b) message media providers;
c) advertising media providers;
d) email notification message providers,[GMS5]
e) whereby, said IVR delivers a merged digital media signal comprised of two or more of digital media content server side sources to a connected digital TV receiver.[GMS6]

5. The IVR as set forth in claim 4, wherein one of said at least two independent server side digital media content overlay the other.

6. The IVR as set forth in claim 1, comprising:
a) an electronic memory;
b) one or more data processors[GMS7];
c) one or more data buses communicating with said memory, said data processor, said network interface and said TV media interface.

7. The IVR as set forth in claim 6, in which said memory comprises;
i) a single address space;
ii) a partitioned memory, including more than one address space.

8. The IVR as set forth in claim 6, in which said memory is comprised;
(1) volatile memory;
(2) non-volatile memory.

9. The IVR as set forth in claim 6, in which said electronic memories are configured to store information comprising:
(1) media data;
(2) program code;

10. The IVR as set forth in claim 6, in which said IVR is comprised of;
i) one or more microprocessors;
ii) a dedicated logic processor;
iii) one or more FPGAs;
iv) Hardwired logic
v) A combination of separate monolithic ICs;
vi) A single System on a Chip (SoC).

11. The IVR as set forth in claim 1, in which said network interface comprise
a) a serial digital interface;
b) a parallel digital interface;

12. The IVR as set forth in claim 1[GMS8], in which said IVR comprises:
a) an Integrated IVR disposed entirely within one of said local digital devices;
wherein said digital connection of said TV media interface is also adapted to interface with others of said local digital devices.

13. The IVR as set forth in claim 1, in which said network interface comprise
a) a wired connection, comprising:
i) Ethernet IEE 802.3.
b) A wireless connection comprising:
i) Wi-Fi;
ii) Wireless USB;
iii) Ultra Wide Band (UWB);
iv) Bluetooth;
v) IEEE 802.11
vi) A wireless broadband Digital Subscriber Line (DSL);
vii) A Wireless Cable Modem;
viii) A Wireless Terrestrial connection.

14. The IVR as set forth in claim 1, in which said TV media interface comprises a physical connector, said connector comprising:
a) a Universal Serial Bus (USB) connector:
b) a Secure Digital (SD) memory card connector;
c) a CableCARD connector;
d) a Peripheral Component Interconnect (PCI) connector;
e) an Inter-Integrated Circuit (I²C) connector;
f) A Serial Peripheral Interface (SPI) bus.[SS9]

15. The IVR as set forth in claim 1, in which said network interface communicates with said independent Server side sources across said communication boundary, with communication protocols comprising:
a) Transmission Control Protocol/Internet Protocol (TCP/IP);[SS10]
b) Hypertext Transfer Protocol (HTTP);
c) Real-Time Streaming Protocol (RTSP).

16. The IVR as set forth in claim 1 comprising:
a) monetizing means for monetizing the playing of video advertisements, wherein said playing of video advertisements means comprise:
i) pausing video being viewed,
ii) playing an advertisement,
iii) resuming play of video being viewed.

17. The IVR as set forth in claim 1 comprising:
a) monetizing means for monetizing transactions of information crossing said communication boundary in either direction to or from said IVR,
i) wherein said monetizing means comprise:
ii) a plurality of accounts for tracking said transactions of information, said accounts comprising:
(1) local storage accounts stored in local memory disposed within said IVR;
(2) remote storage accounts stored in remote memory accessible through said digital network interface,
iii) whereby a fee can be charged for ones of said tracked transactions;

18. The IVR as set forth in claim 17 wherein;
i) said transactions of information comprise[GMS11]:
(1) accessing a single item of content by a user of the IVR;
(2) rendering an advertisement by an advertiser each time said advertisement is rendered by said IVR;
(3) access of statistical information from said IVR by a statistics user;
(4) recommendations to a user of said IVR based on said user's usage history
(5) transfer of a notification from a server to a user, in which said notification comprises:
(a) an email from said server to said user;
(b) an instant message from said server to said user;
(c) a notification message to an individual user from sender of said notification message, in which said notification message, said notification message comprising:
(i) a discount coupon that is displayed to said individual user;
(d) a charitable donation given by a user of the IVR in response to a message received by said user.

19. An Internet Video Receiver (IVR) apparatus disposed on a one (Client) side of a communication boundary, said apparatus comprising:
a) a TV media interface configured to interface with an analog input connector common to a plurality of local analog devices disposed on the Client side of said boundary, said local analog devices comprising:
i) a analog input television display;
ii) other analog input media devices;
b) A digital network interface adapted to retrieve multiple items of digital media content from any of a plurality of independent sources, said independent sources comprising:
i) independent Server side sources, said independent Server side sources disposed on the opposite (Server) side of said communication boundary, said independent Server side sources comprising:
(a) one or more digital networks, comprising:
(i) the Internet;
(ii) one or more WANs;
(iii) one or more LANs;
(iv) one or more computers each having a digital connection compatible with said network interface;[GMS12]
ii) independent Client side sources, wherein said independent Client sides sources comprise:
(1) local sources stored in an memory disposed within said IVR;
(2) local sources stored on local area networks disposed on said client side of said boundary;
c) a Codec for compression/decompression of received digital media adapted to convert said received digital media into a compressed/decompressed media format compatible with said local analog device interface;
d) a digital media merging means for merging at least two of selected ones of said retrieved digital media content items into a merged digital media item and delivering said merged digital output item as said received digital media to said Codec;
e) A Virtual File System (VFS) means for accessing, retrieving and storing said retrieved multiple digital content items in a VFS format, wherein said VFS is compatible with said independent Server side sources, and further, wherein said VFS is compatible with said TV media interface;
f) A Function Control[GMS13] means for controlling IVR functions, said IVR functions comprising:
(1) Selection of said digital media content items to be retrieved from said independent Server side sources,
(2) Selection of said digital media content items to be merged by said digital media merging means;
(3) Selection of said merged digital output to be delivered;
(4) Selection of recipients to receive said delivery of said merged digital output;
g) Whereby two independent types of digital media content from at least two of said independent sources can be independently retrieved, jointly merged and simultaneously delivered to a connected analog input TV through said TV media interface.

20. The Internet Video Receiver (IVR) apparatus as set forth in claim 19, further comprising:
a) an analog input interface adapted to connect to an external source providing input analog media [GMS14];
b) an A/D converter disposed within said IVR, communicating with said analog input interface to receive said input analog media and convert it to an intermediate digital media presented to said Codec as said received digital media.
